(19) United States
(12) Patent Application Publication
(10) Pub. No.: US 2002/0136590 A1
(43) Pub. Date: Sep. 26, 2002

(54) Personalized event/theme photograph album

(76) Inventor: Barry Himmel, Brooklyn, NY (US)

Correspondence Address: Jean-Marc Zimmerman, Esq., 226 St. Paul Street, Westfield, NJ, 07090, US

(21) Appl. No.: 10/139,804

(22) Filed: May 7, 2002

Related U.S. Application Data
(63) Continuation-in-part of application No. 09/377,413, filed on Aug. 20, 1999, now abandoned.
Application No. 09/377,413 is a continuation-in-part of application No. 08/900,380, filed on Jul. 21, 1997, now abandoned.

(51) Int. Cl. B42F 13/00

(52) U.S. Cl. 402/73

(57) ABSTRACT

A personalize event/theme photograph album having a personalized cover. The cover has a main photograph from a plurality of photographs of the event which has been electronically reproduced to have the appearance of an oil-on-canvas painting. The cover binds the plurality of photographs in the album. The event may be a wedding, anniversary, vacation, etc.

### CROSS-REFERENCE OF RELATED APPLICATIONS

This is a Continuation-in-Part of U.S. patent application Ser. No. 09/377,413 filed on Aug. 20, 1999 which is a Continuation-in-Part of U.S. patent application Ser. No. 08/900,380 filed on Jul. 21, 1997.

### FIELD OF THE INVENTION

The present invention relates to the field of photograph albums, and more particularly to a personalized event/theme photograph album having an exterior surface onto which is reproduced a main event/theme photograph of an event or other cherished memory assembled in the album.

### BACKGROUND OF THE INVENTION

Conventional photograph albums used to store photographs come in many different shapes, sizes and styles. Such albums are widely used and are typically purchased off the shelf in stores.

Although the exterior surfaces, of such albums, are typically nondescript, they can be customized by printing or hot stamping names, dates, titles and/or designs on the exterior surface of the album.

### SUMMARY OF THE INVENTION

A personalized event/theme photograph album having an exterior surface or cover onto which a main event/theme photograph of an event or other cherished memory is electronically reproduced and a plurality of photograph album sheets for assembling the photographs of the event or other cherished memory. The photographs assembled in the album may include the main event/theme photograph.

Preferably, the photograph has the appearance of an oil-on-canvas painting.

### BRIEF DESCRIPTION OF THE FIGURES

FIG. 1 illustrates a front view of an uncovered binder's board according to the present invention.

FIG. 2 illustrates a top view of a material sheet having a main event/theme photograph reproduced thereon according to the present invention.

FIG. 3 illustrates a front view of a personalized event/theme photograph album according to the present invention.

FIG. 4 illustrates a general flowchart for personalizing the personalized event/theme photograph album.

### DETAILED DESCRIPTION OF THE INVENTION

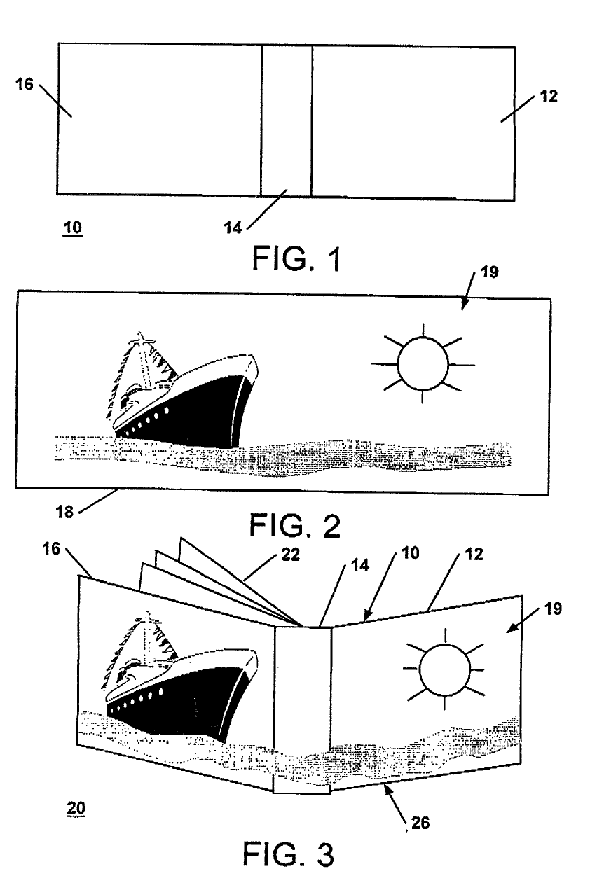

Referring to FIGS. 1-3, there is shown an exemplary embodiment of a covered photograph event/theme album 20 according to the present invention. Album 20 includes uncovered binder's board 10 having back, spine and front surfaces 12, 14 and 16, respectively. The uncovered binder's board 10 is covered with a flexible material sheet 18 having the image 19 of a main event/theme photograph reproduced thereon, as best seen in FIG. 2, to create an album cover 26. The album 20 further includes a plurality of photograph album sheets 22 for assembling the plurality of photographs of the event or other cherished memory. The number of album sheets 22 is a function of the predetermined number of photographs to be assembled in the album 20.

Referring still to FIG. 2, the image 19 of the main event/theme photograph is selected from a plurality of event/theme photographs directly related to the event or other cherished memory. The image 19 of the photograph is electronically reproduced onto the material sheet 18 of unstretched canvas or other printable material sheet so that it has the appearance of an oil painting. Sheet 18 is then cut to a desired size and shape to fit onto the back surface, spine and front surface 12, 14 and 16 of binder's board 10 to create the album cover 26. Sheet 18 is affixed to back surface, spine and/or front surface 12, 14 and 16, respectively, by an adhesive or any other coupling means.

Unlike mass produced photograph albums having a generic cover design bearing no relation to the contents of the album, each one of the albums 20 would be a unique, one-of-a-kind album whose main event/theme photograph on the binder's board 10 has a direct relationship to the personalized contents of the album 20 either by being an enlargement of one of the photographs bound in the album or by having been taken at the same event as the other photographs bound inside the album 20. In addition, unlike conventional photograph albums, the image on the back surface, spine and front surface 12, 14 and 16, respectively, preferably, depicts a single panoramic view of the main event/theme photograph, as best seen in FIG. 2. Alternately, the back and front surfaces 12 and 16, respectively, mirror one another and depict the same main event/theme photograph.

The personalized event/theme photograph album 20 can assemble photographs related to any event including, but not limited to, weddings, birthdays, anniversaries, bar/bat mitzvahs, vacations or other cherished memory.

The reproduced image 19 of the personalized event/theme photograph album 20 can depict a person in front of a world famous landmark such as the Empire State Building, the White House, the Eiffel Tower, etc. Such an image is created by taking a photograph of the person in front of a blank backdrop, such as a white screen, and electronically adding the landmark scene selected by the person. The landmark scene may include other vacation scenes such as theme parks, national parks, cruise ships, etc.

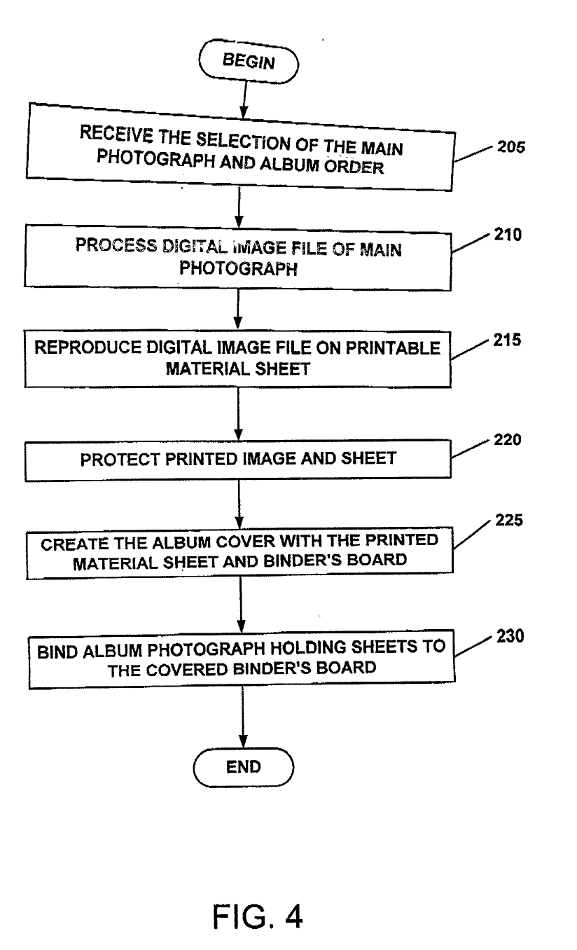

Referring now to FIG. 4, the method of personalizing a event/theme photograph album 20 begins at Step 205 where an album order is received. The album order has a main event/theme photograph selection from a set photographs representative of the event or theme such as without limitation, a vacation, wedding, birthday, anniversary, and bar/bat mitzvah or other cherished memory, that had been created from the event or occasion. Furthermore, the album order may include the size of the album (number of pictures).

Step 205 is followed by Step 210, an image processing step. The image processing step may include digitally scanning the main event/theme photograph, if the photograph is submitted in a hardcopy format, to create a digital image file of the main event/theme photograph. Otherwise, the digital image file is “cleaned up” or “cropped” by electronically manipulating the digital image file, such as without limitation, for proper sizing and color manipulation. For example, when personalizing the album 20, the digital image file may alter the image to black & white, sepia or a combination of color and black & white. Furthermore, the digital image file may be altered by adding text, eliminating people or objects, superimposing the main subject in an entirely different location (such as a landmark scene), etc. In the exemplary embodiment shown in FIG. 2, the digital image file was enlarged to create a single panoramic view of the main photograph.

It should be noted that the digital image file may be the result of splicing two photographs together to obtain a single panoramic view. The digital image file may be a photograph of a person, family, friend, community, animal, etc. The digital image file, of the person, family, friend, etc., could be superimposed in front of a world famous landmark such as the Empire State Building, the White House, the Eiffel Tower, etc.

After the image processing Step 210, Step 210 is followed by Step 215 where the main photograph is electronically reproduced on the material sheet 18. In the preferred embodiment, the reproduction is created by printing the digital image file using a 12-color wide format ink jet printer, which can accommodate a material sheet 18 of up to 48″ wide. The printer, while outputting 300 dpi, is able to produce a high quality “photographic” image by virtue of the multitude of inks and unlimited range of hues, densities, shades, etc. In the preferred embodiment, an artist canvas is used as the material sheet 18. The canvas must be sized to the binder's board 10 for the selected album size wherein the size of the album 20, preferably, was identified during Step 205.

Step 215 is followed by Step 220, an image protecting step. During the image protecting Step 220, a protective coating is applied to the printed side of the material sheet 18 or canvas. In the preferred embodiment, the protective coating is sprayed with a triple UV emulsified protective coating. Such coating not only makes the canvas and the ink water resistant but also protects the canvas and ink from sunlight, yellowing, fading and cracking. The protecting Step 220 also includes allowing the protective coating to dry.

When Step 220 is complete and thus the coated material sheet 18 is dry, Step 220 is followed by Step 225 where the material sheet 18 is affixed to the binder's board 10. However, the material sheet 18 may need to be trimmed before being mounted on the binder's board 10 to create an album cover 26, as best seen in FIG. 3. The combination of printing and coating with a protective coating creates an oil-on-canvas appearance when the sheet 18 is canvas.

After the album cover 26 is created in Step 225, Step 225 is followed by Step 230. During Step 230, the album sheets 22 are bound in the album cover 26 and cased in for approximately 12 hours or longer.

Numerous modifications to and alternative embodiments of the present invention will be apparent to those skilled in the art in view of the foregoing description. Accordingly, the foregoing description is to be construed as illustrative only and is for the purpose of teaching those skilled in the art the best mode of carrying out the invention. Details of the structure may be varied substantially without departing from the spirit of the invention and the exclusive use of all modifications which come within the scope of the appended claims is reserved.

What is claimed is:

1. A personalized event photograph album comprising:
a binder's board;
a material sheet having a digital image of a main event photograph, of an event, electronically reproduced thereon and affixed to the binder's board; and
a plurality of photograph album sheets assembling a plurality of photographs, the photographs being directly related to the event, the sheets are adapted to be coupled to the binder's board.

2. The album according to claim 1, wherein the material sheet is canvas and the digital image is reproduced in a manner to have an appearance of an oil painting on the canvas.

3. The album according to claim 1, wherein the binder's board includes a front surface, a back surface and a spine coupled together.

4. The album according to claim 3, wherein the digital image of the main event photograph depicts a panoramic view of the main event photograph and is reproduced across the front surface, the back surface and the spine.

5. The album according to claim 3, wherein the digital image of the main event photograph is reproduced across the front surface, and a mirror image of the digital image is printed on the back surface.

6. The cover according to claim 1, wherein the event includes one of a wedding, anniversary, birthday, vacation, bar/bat mitzvah or other cherished memory.

7. The album according to claim 1, wherein the material sheet is printable and the digital image is printed on the material sheet.

8. A personalized photograph album, comprising:
a plurality of album sheets holding a plurality of photographs of a cherished memory; and,
a cover for binding the plurality of album sheets, the cover having a reproduced thereon a main photograph directly related to the plurality of photographs.

9. The album according to claim 8, wherein the cover includes canvas and the reproduced main photograph is reproduced in a manner to create an appearance of an oil painting on the canvas.

10. The album according to claim 8, wherein the cover includes binder's board having a front surface, a back surface and a spine coupled together.

11. The album according to claim 10, wherein the main photograph is reproduced to have a panoramic view of the main photograph and is printed across the front surface, the back surface and the spine.

12. The album according to claim 10, wherein the main photograph is printed across the front surface, and a mirror image of the main photograph is printed on the back surface.

13. The album according to claim 1, wherein the cherished memory includes one of a wedding, anniversary, birthday, vacation, or bar/bat mitzvah.

14. A method of personalizing a photograph album comprising the steps of:
processing a digital image file of the main photograph of a plurality of photographs wherein the main photograph is directly related to the plurality of photographs;
reproducing the digital image file on a material sheet;
creating an album cover with the material sheet having the reproduced image file; and
binding the plurality of photographs in the album cover.

15. The method according to claim 14, wherein the material sheet is canvas.

16. The method according to claim 15, further comprising the step of applying a protective coating to the material sheet and the reproduced image file wherein the reproduced image file has an appearance of an oil painting on canvas.

17. The method according to claim 14, wherein the plurality of photographs are of an event comprising one of a wedding, birthday, anniversary, vacation, or bar/bat mitzvah.

18. The method according to claim 14, wherein:
the processing step includes the step of:
enlarging the main photograph to create a panoramic view; and
the reproducing step includes the step of:
printing the panoramic view over the material sheet so that the printed panoramic view extends over a front surface, a back surface and a spine of the album cover.

19. The method according to claim 14, wherein the processing step includes superimposing the digital image file on a landmark scene.

20. The method according to claim 14, wherein the creating step includes affixing the material sheet having the reproduced image file on the binder's board.
